(19) United States
(12) Patent Application Publication
(10) Pub. No.: US 2025/0307285 A1
(43) Pub. Date: Oct. 2, 2025

(54) SYSTEMS AND METHODS FOR RECOMMENDING INFORMATION ITEMS FOR FULFILLMENT-BASED NATURAL LANGUAGE QUERIES

(71) Applicant: Walmart Apollo, LLC, Bentonville, AR (US)

(72) Inventors: Qinwei Zhu, Seattle, WA (US); Robert Kyle Sosin, New York, NY (US); Adithya Shankar Selvaraj, Dindigul (IN); Thenappan Ramanathan, Bangalore (IN); Sreekanth Suruvu, Hindupur (IN)

(21) Appl. No.: 19/088,241

(22) Filed: Mar. 24, 2025

Related U.S. Application Data
(60) Provisional application No. 63/570,406, filed on Mar. 27, 2024.

(51) Int. Cl. G06F 16/334; G06Q 10/0836

(52) U.S. Cl. CPC G06F 16/334; G06Q 10/0836

(57) ABSTRACT

This application is directed to systems and methods for identifying relevant information items on a cloud-based service platform. In some embodiments, a disclosed method includes obtaining one or more query messages having a natural language format and generating a user request based on the one or more query messages. The user request includes item information of one or more items, a fulfillment type for managing the one or more items, and a data operation type for processing the item information. The disclosed method further includes identifying a target user and an information source including candidate information items associated with the item information based on the data operation type, generating one or more information items from the candidate information items provided by the information source based on the fulfillment type, and generating instructions to display the one or more information items on an electronic device associated with the target user.

### TECHNICAL FIELD

This application is a continuation of and claims benefits to U.S. Provisional Patent Application No. 63/570,406, filed Mar. 27, 2024, titled “Systems and Methods for Recommending Information Items for Fulfillment-Based Natural Language Queries,” which is incorporated by reference in its entirety.

### TECHNICAL FIELD

This application relates generally to natural language processing and, more particularly, to systems and methods for natural language processing of user queries.

### BACKGROUND

A cloud-based service platform may operate by presenting information items associated with catalog items on user interfaces and prompting user actions with selected information items. The information items as presented may be identified in response to user-entered queries, encompassing item description or initial user actions related to previously displayed information items on the user interfaces. The user-entered queries or the user actions necessitate a substantial level of user engagement with the interfaces of the service platform, precluding concurrent execution of other tasks. In many instances, adjustments to user-entered queries and actions must be made and gradually adjusted based on the limited information available via the user interfaces. It is inconvenient and inefficient to rely solely on user-entered queries or actions to interact with the cloud-based service platform's interfaces to identify information items matching a user's desired product service.

### SUMMARY

In various embodiments, a system including a non-transitory memory configured to store instructions thereon and at least one processor is disclosed. The at least one processor is configured to obtain one or more query messages having a natural language format and generate a user request associated with one or more items by processing the one or more query messages using a natural language processing model. The user request includes item information associated with the one or more items, a fulfillment type for managing the one or more items, and a data operation type for processing the item information. The at least one processor is further configured to, in response to the user request, identify an information source including a set of candidate information items associated with the item information based on the data operation type, generate one or more information items from the set of candidate information items provided by the information source based on the fulfillment type, identify a target user based on at least the data operation type, and generate instructions to display the one or more information items on an electronic device associated with the target user.

In various embodiments, a computer-implemented method is disclosed. The computer-implemented method includes steps of obtain one or more query messages having a natural language format and generating a user request associated with one or more items by processing the one or more query messages using a natural language processing model, where the user request includes item information associated with the one or more items, a fulfillment type for managing the one or more items, and a data operation type for processing the item information. The computer-implemented method further includes steps of, in response to the user request, identifying an information source including a set of candidate information items associated with the item information based on the data operation type, generating one or more information items from the set of candidate information items provided by the information source based on the fulfillment type, identifying a target user based on at least the data operation type, and generating instructions to display the one or more information items on an electronic device associated with the target user.

In various embodiments, a non-transitory computer readable medium having instructions stored thereon is disclosed. The instructions, when executed by at least one processor, cause at least one device to perform operations including obtaining one or more query messages having a natural language format; generating a user request associated with one or more items by processing the one or more query messages using a natural language processing model, where the user request includes item information associated with the one or more items, a fulfillment type for managing the one or more items, and a data operation type for processing the item information; and in response to the user request: identifying an information source including a set of candidate information items associated with the item information based on the data operation type; generating one or more information items from the set of candidate information items provided by the information source based on the fulfillment type; identifying a target user based on at least the data operation type; and generating instructions to display the one or more information items on an electronic device associated with the target user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of users, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of a process of providing one or more information items to a target user, in accordance with some embodiments;

FIG. 9 is a block diagram of an information processing system, in accordance with some embodiments;

FIG. 10 is a flow diagram of a process of processing one or more natural language query messages to generate information items for a target user, in accordance with some embodiments;

FIG. 11 is a diagram illustrating a set of graphic user interfaces displayed for receiving and processing natural language query messages, in accordance with some embodiments;

FIG. 12 is a diagram illustrating a set of graphic user interfaces displayed for receiving and processing natural language query messages, in accordance with some embodiments; and

FIG. 13 is a flowchart illustrating a method for managing information, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for managing information items (e.g., data items representative of items included in a catalog) to be distributed to users in response to user queries or requests on a cloud-based service platform. The cloud-based service platform hosts a user application having a plurality of user accounts associated with a plurality of users (e.g., guest users, registered users). The user application includes user interfaces on which information items may be displayed to prompt user actions. The user actions may create further tasks for execution, such as fulfillment tasks, that can be executed by online and/or offline processes associated with the cloud-based service platform. Fulfillment options and speeds of further processing can directly influence user experience and subsequent decision-making on the cloud-based service platform. In some embodiments, fulfillment-based natural language queries are processed to extract item information, a fulfillment type, and a data operation type and identify relevant information items, which thereby enables an intuitive and quick solution to process information items (e.g., by a search, information filtering, or order processing). Natural language queries allow the users to express their fulfillment needs when the user application displays different functional pages, independently of information content presented for the user application. Examples of the natural language queries include, but are not limited to, “search for a dog leash for pickup,” “find laundry detergent available for delivery,” or “add this item to cart for shipping.”

In some embodiments, each user query includes a respective user-defined fulfilment type (e.g., instore pickup, delivery, shipping) and data processing results are presented adaptively based on the fulfillment type. For example, a user query may include a voice-activated search request for a particular product item that can be picked up from a store by a user. An information item associated with the particular item may be presented as a search result, prompting the user to select the displayed information item and add the particular item to a cart, e.g., using voice. Fulfillment-based natural language queries have a higher rate of engagement and higher satisfaction with the service provided by the cloud-based service platform. Additionally, the cloud-based service platform can process user requests more independently without heavily involving user actions.

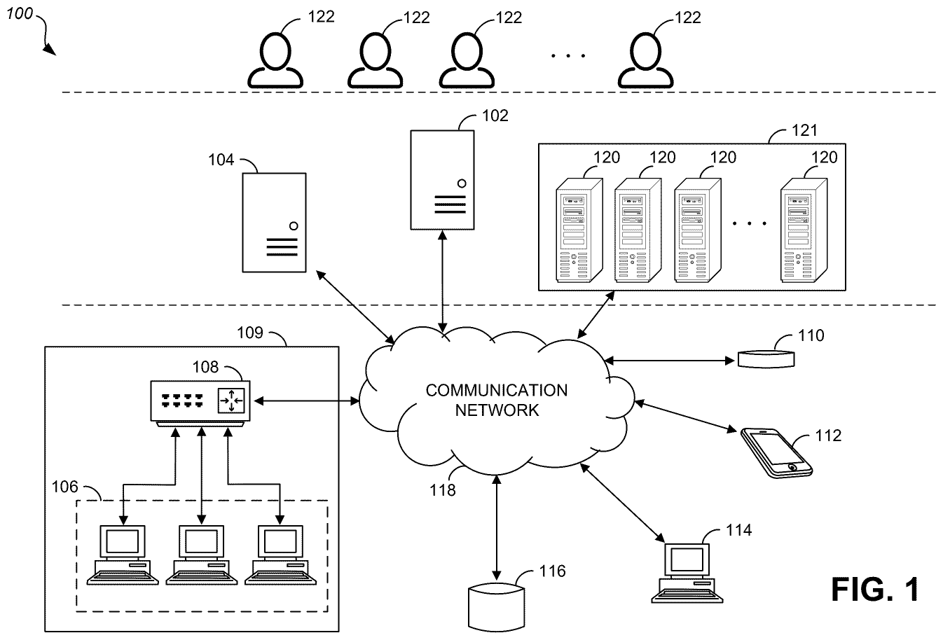

FIG. 1 is a network environment 100 configured to provide a user application (e.g., a network interface application, an online shopping application, etc.) to a plurality of users, in accordance with some embodiments. The network environment 100 includes a plurality of devices or systems configured to communicate over one or more network channels, illustrated as a network cloud 118. For example, in various embodiments, the network environment 100 can include, but is not limited to, a computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the computing device 102 over the communication network 118. The workstation(s) 106 may send data to, and receive data from, the computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the computing device 102 over the communication network 118.

In some examples, the computing device 102 may execute one or more models, such as a natural language processing model 224, etc., to process one or more query messages and generate a user request including item information associated with the one or more items, a fulfillment type for managing the one or more items, and a data operation type for processing the item information. The computing device 102 may identify an information source and a target user based on the data operation type, generate one or more information items provided by the information source based on the fulfillment type, and provide instructions to display the one or more information items on an electronic device associated with the target user.

The computing device 102 is further operable to communicate with the database 116 over the communication network 118. For example, the computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the computing device 102, in some examples, the database 116 can be a local storage device, such as a hard drive, a non-volatile memory, or a USB stick. The computing device 102 may store purchase data received from the web server 104 in the database 116. The computing device 102 may also receive from the web server 104 user session data identifying events associated with browsing sessions, and may store the user session data in the database 116.

In some examples, the computing device 102 generates training data for one or more models (e.g., a natural language processing model 224, etc.) based on historical user session data, etc. The computing device 102 may train the models based on their corresponding training data and may store the model(s) in a database, such as in the database 116 (e.g., a cloud storage).

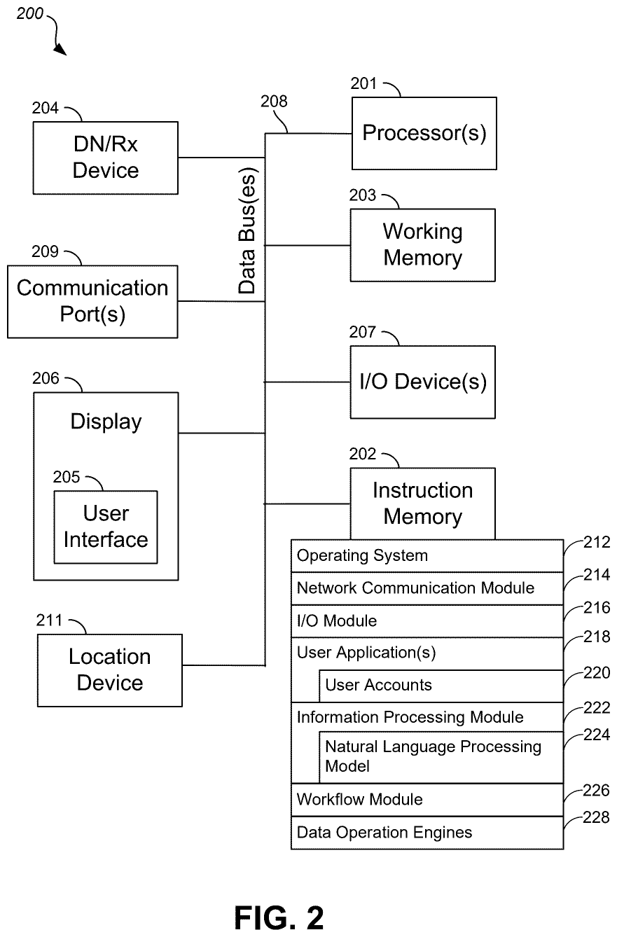

The models, when executed by the computing device 102, allow the computing device 102 to generate a user request from one or more natural language query messages, determine related information (e.g., an information source, a target user) of the user request, and identify one or more information items among the candidate information items for display to the target user. For example, the computing device 102 may obtain the models from the database 116. The computing device 102 may execute the models (e.g., a natural language processing model 224 in FIG. 2) to process one or more query messages received in a natural language format, determine context among the one or more query messages, and generate a user request including the item information, the fulfillment type, and the data operation type.

In some embodiments, the computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, computing device 102 may generate ranked item recommendations for items to be displayed on the website to a user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and customer computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the computing device 102 and/or the cloud-based engine 121. In some embodiments, the computing device 102 and/or the cloud-based engine 121 may obtain one or more query messages having a natural language format and generate a user request associated with one or more items by processing the one or more query messages using a natural language processing model. The user request may include item information associated with the one or more items, a fulfillment type for managing the one or more items, and a data operation type for processing the item information. In response to the user request, the computing device 102 and/or the cloud-based engine 121 may identify an information source including a set of candidate information items associated with the item information based on the data operation type, generate one or more information items from the set of candidate information items provided by the information source based on the fulfillment type, identify a target user based on at least the data operation type, and generate instructions to display the one or more information items on an electronic device associated with the target user. Examples of the fulfillment type include, but are not limited to, delivery from a warehouse, shipping from a store, and user pickup. Examples of the data operation type include, but are not limited to, a search option for searching for target information items, a refinement option for filtering information, and an engagement option for adding an item associated with an information item to a virtual shopping cart.

FIG. 2 is a block diagram of a computing device 200, in accordance with some embodiments of the present teaching. In some embodiments, each of the computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output (I/O) devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the computing device 102 may determine a local geographical area (e.g., town, city, state, etc.) of its position.

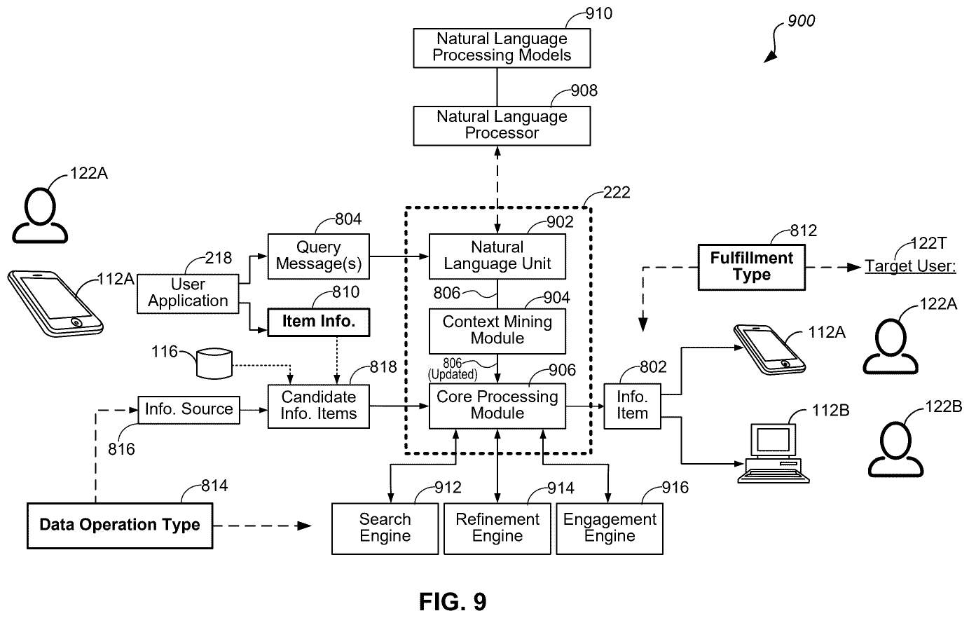

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online interface application that may provide online services to registered users and/or guest users; and
Information processing module 222 that is executed to obtain one or more query messages having a natural language format, generate a user request associated with one or more items by processing the one or more query messages using a natural language processing model 224, and generate instructions to display one or more information items, which are identified based on the user request, on an electronic device associated with a target user;
Workflow module 226 for receiving a request for a workflow associated with a data operation type and providing implementation details of the workflow to the information processing module 222; and
Data operation engines 228 for implementing functions identified by a data operation type that is determined based on natural language query messages, where in some embodiments, the data operation engines 228 include a search engine, a refinement engine, and an engagement engine (FIG. 9).

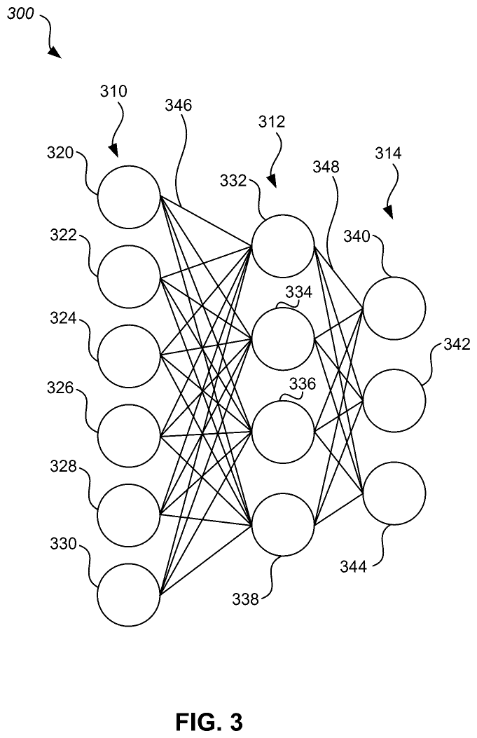

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by:

$${x}_{j}^{( n + 1 )} = f ( {Σ}_{i} {x}_{i}^{( n )} \cdot {w}_{i , j}^{( n )} ) \qquad ( 1 )$$

where the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δⱼ⁽ⁿ⁾ may be recursively calculated as

$${δ}_{j}^{( n )} = ( {Σ}_{k} {δ}_{k}^{( n + 1 )} \cdot {w}_{j , k}^{( n + 1 )} ) \cdot {f}^{′} ( {Σ}_{i} {x}_{i}^{( n )} \cdot {w}_{i , j}^{( n )} ) \qquad ( 3 )$$

based on δⱼ⁽ⁿ⁺¹⁾ if the (n+1)-th layer is not the output layer, and

$${δ}_{j}^{( n )} = ( {x}_{k}^{( n + 1 )} - {t}_{j}^{( n + 1 )} ) \cdot {f}^{′} ( {Σ}_{i} {x}_{i}^{( n )} \cdot {w}_{i , j}^{( n )} ) \qquad ( 4 )$$

if the (n+1)-th layer is the output layer 34, wherein f′ is the first derivative of the activation function, and γⱼ⁽ⁿ⁺¹⁾ is the comparison training value for the j-th node of the output layer 314.

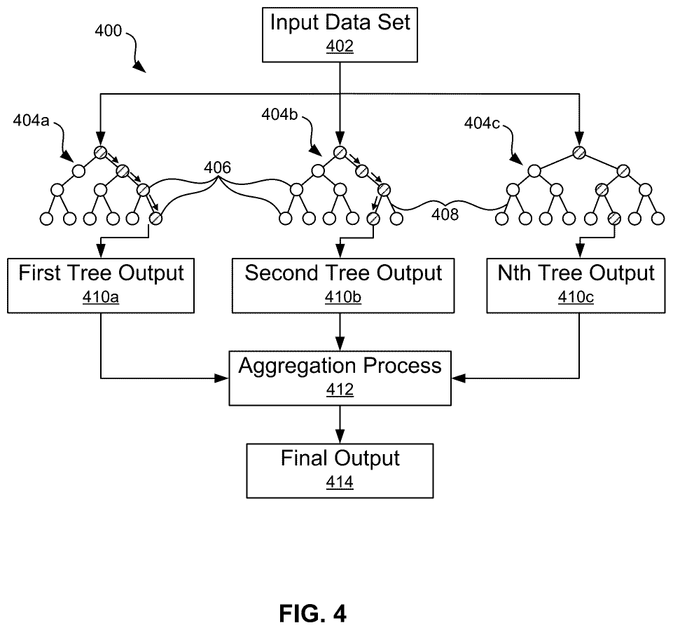

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

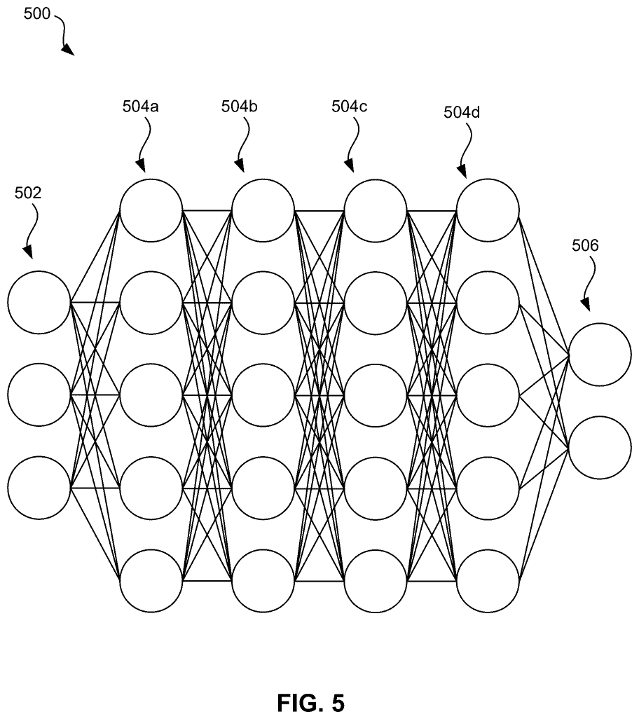

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( log x )} {e}^{{Σ}_{i} {f}_{i}^{d} ( {d}_{i} )} \qquad ( 8 )$$

where d represents one or more features of the independent variable x.

It will be appreciated that automated information item selection, as disclosed herein, particularly for large platforms such as e-commerce network platforms, is only possible with the aid of computer-assisted machine-learning algorithms and techniques, such as the natural language processing model 224. In some embodiments, information item selection processes including the trained natural language processing model 224 are used to perform operations that cannot practically be performed by a human, either mentally or with assistance. Such operations include, but not limited to, recognizing item information associated with the one or more items, a fulfillment type for managing the one or more items, and a data operation type for processing the item information in one or more query messages. The fulfillment type has a first number of options, and the data operation type has a second number of options. Each option of the fulfillment type and the data operation type may have two or more variants. Additionally, the one or more items may be selected from a plurality of items for which item information is stored in a database (e.g., database 116 in FIG. 1). In some situations, the database stores information of millions of items, which cannot practically be processed by a human. It will be appreciated that a variety of information item selection techniques can be used alone or in combination to exact the item information, the fulfillment type, and the data operation type from one or more natural language query messages and select one or more relevant information items accordingly.

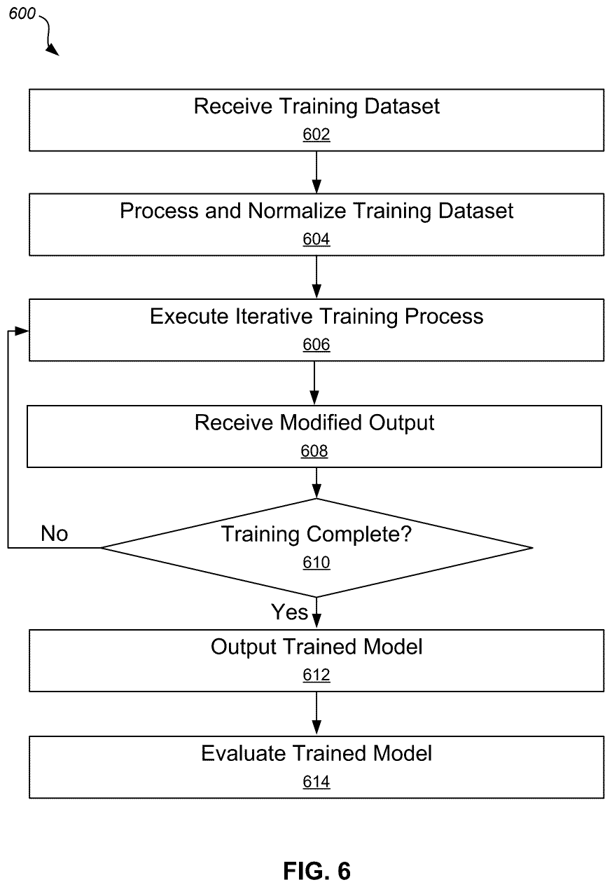

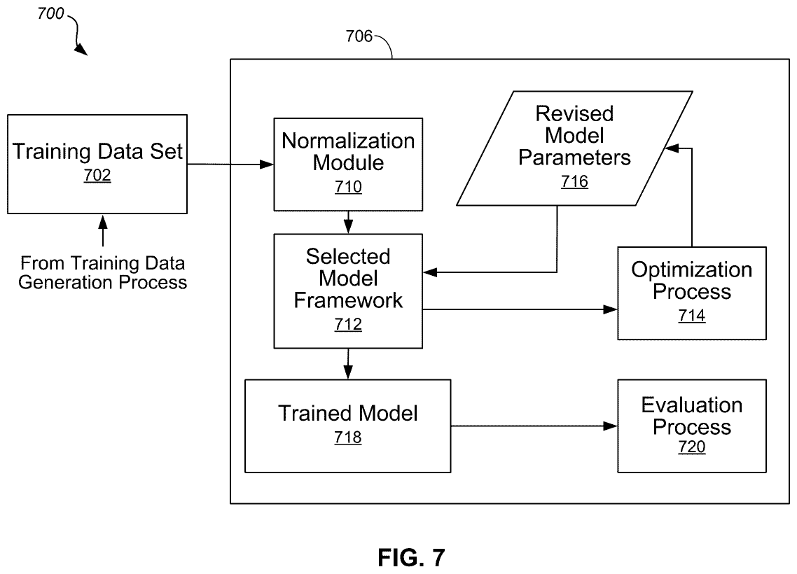

In some embodiments, an information item selection method can include and/or implement one or more trained models, such as a natural language processing model 224. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained natural language processing model 224 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) natural language processing model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

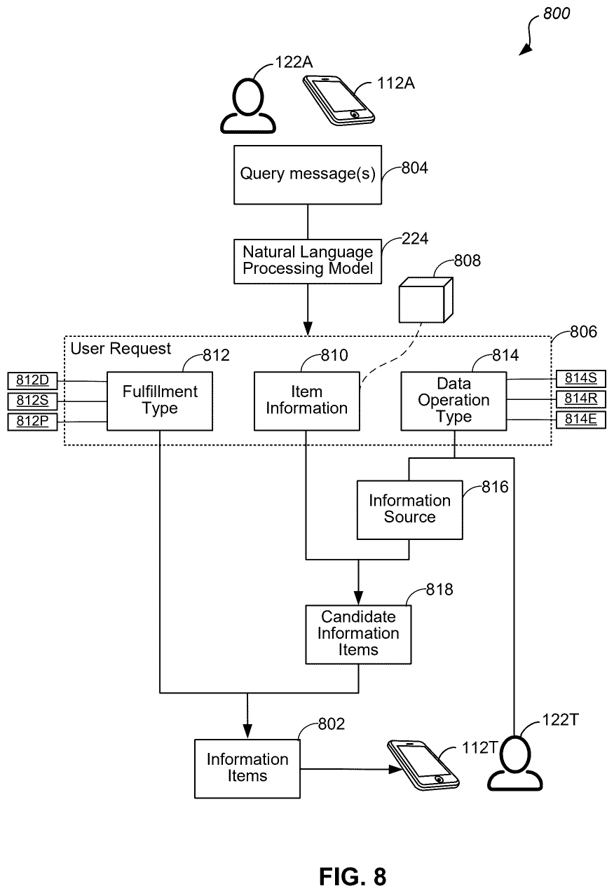

FIG. 8 is a flow diagram of a process 800 of providing one or more information items 802 to a target user 122T, in accordance with some embodiments. The process 800 may be implemented by any suitable system (e.g., including a computing device 102 and/or a cloud-based engine 121 in FIG. 1). A user application 218 (FIG. 2) may be associated with a plurality of users 122 (e.g., registered users, guest users) and/or have a plurality of user accounts 220. While the user application 218 is executed, one or more query messages 804 are collected via an electronic device 112A associated with a first user 122A. The one or more query messages 804 have a natural language format and are processed using a natural language processing model 224 (FIG. 2) to generate a user request 806 associated with one or more items 808. The user request 806 may include item information 810 associated with the one or more items 808, a fulfillment type 812 for managing the one or more items 808, and a data operation type 814 for processing the item information 810. In response to the user request 806, an information source 816 and the target user 122T may be determined based on the data operation type 814. The information source 816 may include a set of candidate information items 818 associated with the item information 810 and the one or more items 808. Based on the fulfillment type 812, one or more information items 802 are generated based on the set of candidate information items 818 provided by the information source 816. The one or more information items 802 may be further presented on an electronic device 112T associated with the target user 122T. Stated another way, instructions are generated to display the one or more information items 802 on the electronic device 112T associated with the target user 122T.

Examples of the fulfillment type 812 include, but are not limited to, delivery from a delivery option 812D, a shipping option 812S, and a pickup option 812P. Examples of the data operation type 814 include, but are not limited to, a search option 814S for searching for target information items, a refinement option 814R for filtering information, and an engagement option 814E for adding an item associated with an information item to a virtual shopping cart. Additionally, the one or more items 808 may be associated with information displayed to the first user 122A providing the query message(s) 804, candidate information items 818, or the one or more information items 802 displayed to the target user 122T. The associated item information 810 are associated with a subset of the information displayed to the first user 122A, the candidate information items 818, and the one or more information items 802. In some embodiments, for the user request 806, the item information 810 may include an item type (e.g., “toys”), and each of the one or more information items 802 presented to the target user 122T represents a respective item 808 of the item type and includes one or more of: a brand name, a quantity, a package size, a price, and an image of the respective item 808.

In one non-limiting example, a query message 804 is “Search for toys for shipping,” which is analyzed using the natural language processing model 224. A user request 806 is generated, and includes a shipping option 812S and a search option 814S identified as the fulfillment type 812 and the data operation type 814, respectively. The user request 806 is broadly associated with an item type (e.g., “toys”). The item information 810 includes the item type (e.g., “toys”). The search option 814B may be further used to identify that the first user 122A as the target user 122T and a catalog database as the information source 816. Based on the item type (e.g., “toys”), a plurality of toy items (e.g., 5,000 toy items) may be identified in the catalog database and used as candidate items. A subset of identified toy items may be available for the shipping option 812S and selected based on the fulfillment type 812 of the user request 806. For example, the subset of identified toy products includes 100 toy products that can be shipped from nearby stores, and associated information items 802 of the subset of identified toy products are therefore presented to the first user 122A for further review.

In another non-limiting example, a set of information items have already been displayed on the electronic device 112A associated with the first user 122A. A query message 804 is “I want shipping items only,” and a corresponding user request 806 includes the shipping option 812S and a refinement option 814R identified as the fulfillment type 812 and the data operation type 814, respectively. The user request 806 is associated with “items,” which may be identified as the set of information items currently displayed on the electronic device 112A. The item information 810 includes the set of information items currently displayed on the electronic device 112A, and the one or more items 808 associated with the item information 810 are represented by the set of information items currently displayed. The refinement option 814R may be further used to identify that the first user 122A as the target user 122T and the set of information items as the information source 816. The one or more items 808 are checked to see whether they are available for the shipping option 812S. A subset of items 808 associated with the set of information items currently displayed on the electronic device 112A is available and selected based on the fulfillment type 812 of the user request 806. Information items 802 associated with the subset of items 808 are therefore presented to the first user 122A for further review.

In yet another non-limiting example, a target information item is displayed on the electronic device 112A associated with the first user 122A. A query message 804 is “Add this item for pickup,” and a corresponding user request 806 includes a pickup option 812P and an engagement option 814E. The pickup option 812P is identified as the fulfillment type 812, and the engagement option 814E is identified as the data operation type 814. The user request 806 is associated with “this item,” which may be identified as the target information item currently displayed on the electronic device 112A. The item information 810 includes the target information item currently displayed on the electronic device 112A, and an item 808 associated with the item information 810 is represented by the target information item currently displayed. The engagement option 814E may be further used to identify that an employee at a physical fulfillment location as the target user 122T and the target information item as the information source 816. The item 808 is added to an order for a store pickup. The item 808 associated with the target information item currently displayed on the electronic device 112A is selected based on the fulfillment type 812 of the user request 806. An information item 802 associated with the item 808 (e.g., the target information item) is therefore presented to the target user 122T (e.g., the employee), such that the target user 122T may prepare the item 808 for the user pickup.

FIG. 9 is a block diagram of an information processing system 900, in accordance with some embodiments. The system 900 may be any suitable system (e.g., including a computing device 102 and/or a cloud-based engine 121 in FIG. 1) configured to process natural language query message(s) 804 provided by a first user 122A and generate information items 802 for presentation to a target user 122T. A user application 218 is executed to enable display of a user interface on an electronic device 112A associated with the first user 122A. The first user 122A enters one or more query messages 804 via the user interface. The query message(s) 804 have a natural language format that follows naturally developed language rules in use. In some embodiments, the one or more query messages 804 may be entered as one or more audio signals via a microphone of the electronic device 112A. Alternatively, in some embodiments, each of the one or more query messages 804 is a textual message entered on the user interface by the first user 122A. The system 900 further includes an information processing module 222 and a plurality of data operation engines 228 (FIG. 2). The information processing module 222 is coupled to the user application 218 and configured to generate a user request 806 including item information 810, fulfillment type 812, and data operation type 814 and collaborate with the plurality of engines 228 to generate one or more information items adaptively for presentation to the target user 122T.

In some embodiments, the information processing module 222 further includes a natural language unit (NLU) 902, a context mining module 904, and a core processing module 906. Further, in some embodiments, the information processing module 222 includes a natural language model 224. The natural language unit 902 applies the natural language model 224 to process each of the one or more query messages 804 and determine the user request 806 including the item information 810, fulfillment type 812, and data operation type 814. Alternatively, in some embodiments, the information processing module 222 does not include a natural language model 224 or chooses not to use its own natural language model 224. The natural language unit 902 provides information of the query message(s) 804 to a natural language processor 908 dedicated to natural language processing. The natural language processor 908 may include an internal module distinct from the information processing module 222 or a third-party service module. The natural language processor 908 processes the information of the query message(s) 804 using one or more natural language processing models 910 and determines the user request 806 including the item information 810, fulfillment type 812, and data operation type 814.

In some embodiments, the one or more query messages 804 may include a sequence of two or more query messages in the natural language format. The context mining module 904 is coupled to the natural language unit 902 and may correlate the two or more query messages in the sequence with one another. The context mining module 904 may generate a context including a plurality of context terms by processing each of the sequence of two or more query messages using the natural language processing model 224 separately. Alternatively, the context mining module 904 may generate the context including the associated context terms based on the query message(s) 804 or information of the user request 806 provided by the natural language unit 902. The user request 806 generated by the natural language unit 902 may be further adjusted and improved based on the context. Stated another way, the user request 806 may be generated as a result of natural language processing and context mining. In some embodiments, the sequence of two or more query messages has the same conversation identifier. In some embodiments, two or more query messages 804 are recorded in two or more audio signals in two or more sessions. Alternatively, in some embodiments, the two or more query messages 804 are continuously recorded in a single audio signal and in a single session. In some embodiments, the natural language processing model 224 is trained to understand a user's utterance habits, and extracts the context associated with the user's utterance habits based on the sequence of two or more query messages 804. The sequence of two or more query messages 804 may be successive to one another or separated by an irrelevant messages in between.

In some embodiments, the core processing module 906 receives the user request 806 and generates the one or more information items 802 presented to the target user 122T adaptively based on the user request 806. The user request 806 includes the item information 810, the fulfillment type 812, and the data operation type 814. The item information 810 may indicate, and help identify, information item(s) 802 resulting from a data operation of the data operation type 814. The data operation type 814 may determine the target user 122T to whom the one or more information items 802 are presented. The data operation type 814 may also determine an information source 816 of candidate information items 818 from which the one or more information items 802 are determined or selected. Based on the data operation type 814, the information source 816 of candidate information items 818 may be a single information item currently displayed on the electronic device 112A, a set of information items currently displayed on the electronic device 112A, or one or more datasets in a database 116. In accordance the fulfillment type 812, the one or more information items 802 are determined based on the candidate information items 818.

In some embodiments, the information source 816 includes a plurality of data sets stored in one or more databases 116. The fulfillment type 812 is selected from a delivery option 812D associated with a first data set, a shipping option 812S associated with a second data set, and a pickup option 812P associated with a third data set. The one or more information items 802 are extracted based on at least one of the first data set, the second data set, and the third data set stored in the one or more databases 116 based on the fulfillment type 812. Each of the first data set, the second data set, and the third data set may be stored separately and/or in a consolidated manner for the respective option of the fulfillment type 812 and a corresponding requested data operation may be implemented based on the corresponding data set. Alternatively, in some embodiments, the information source 816 includes a database 116. Each candidate information item 818 is stored with a fulfillment indicator in the database 116. The one or more information items 802 are extracted from the database 116 based on the fulfillment indicator of each of the one or more information items 802. The fulfillment indicator of each candidate information item 818 indicates whether it is available for the delivery option 812D, the shipping option 812S, the pickup option 812P, or a combination thereof. A corresponding requested data operation is implemented based on the fulfillment indicators of at least a subset of candidate information items 818 stored in the database 116.

In some embodiments, the data operation type 814 may be selected from a search option 814S, a refinement option 814R, and an engagement option 814E. The core processing module 906 is coupled to a search engine 912 configured to implement the search option 814S, a refinement engine 914 configured to implement the refinement option 814R, and an engagement engine 916 configured to implement the engagement option 814E. The first user 122A belongs to a first user group and provides the one or more query messages 804. The first user 122A may be identified as the target user 122T in accordance with a determination that the data operation type 814 is the search option 814S or the refinement option 814R. A second user 122B belongs to a second user group associated with the system 900 (e.g., a group of store clerks and warehouse workers), and may be identified as the target user 122T in accordance with a determination that the data operation type 814 is the engagement option 814E. In some embodiments, the first user group does not share any common user with the second user group.

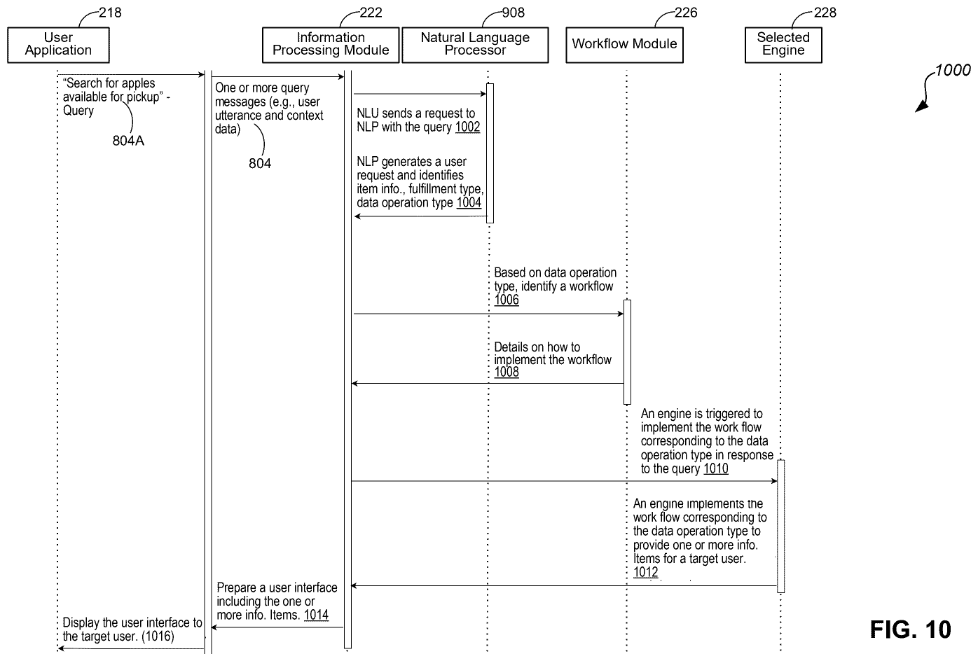

FIG. 10 is a flow diagram of a process 1000 of processing one or more natural language query messages 804 to generate information items 802 for a target user 122T, in accordance with some embodiments. A user application 218 is executed by a system (e.g., an information processing system 900) and collects one or more query messages 804 from a first user 122A. For example, the one or more query messages 804 includes at least a message 804A, “Search for apples available for pickup.” The one or more messages 804 may include an audio signal collected by a microphone, and corresponds to user utterance and context data. The audio signal may be digitalized and converted to the one or more query messages 804. Alternatively and/or additionally, the one or more query messages 804 may be typed (e.g., at once or successively) in a text box displayed on a user interface of the user application 218 and/or the one or more query messages 804 may be selected by clicking on an actionable information item or selecting an option in a dropdown menu displayed on a user interface of the user application 218. An information processing module 222 is coupled to the user application 218, and receives the one or more query messages 804. In some embodiments, a natural language unit (NLU) 902 of an information processing module 222 (FIG. 9) processes the one or more query messages 804 jointly with a context mining module 904 of the information processing module 222 to generate a user request 806 including item information 810, a fulfillment type 812, and a data operation type 814. In some embodiments, the natural language unit 902 sends (operation 1002) the one or more query messages 804 to a natural language processor 908, which generates, and returns to the information processing module 222, the user request 806 including the item information 810, the fulfillment type 812 (operation 1004), and the data operation type 814. The item information 810 may be associated with one or more items 808 associated with one or more information items 802 to be presented to the target user 122T. In some embodiments, the one or more items 808 also correspond to one or more information items that are currently presented by the user application 218 to the first user 122A providing the query message(s) 804.

Upon receiving the data operation type 814 identified in the user request 806, the information processing module 222 acquires (operation 1006) a workflow corresponding to the data operation type 814. In some embodiments, the information processing module 222 is coupled to a workflow module 226 configured to receive a request for the workflow associated with the data operation type 814 and provide implementation details 1008 of the workflow to the information processing module 222. In one non-limiting example, the data operation type 814 is “search,” and the information processing module 222 fetches the implementation details 1008 from the workflow module 226. The workflow module 226 may be an internal functional module distinct from the information processing module 222 or a third-party module external to the system 900.

In some embodiments, the information processing module 222 sends an instruction to one of a plurality of data operation engines 228 selected based on the data operation type 814. The selected one of the plurality of data operation engines 228 is controlled (operation 1010) to implement the workflow corresponding to the data operation type 814 in response to the user request 806 and provide (operation 1012) the one or more information times 802 to the information processing module 222. In one non-limiting example, the query messages 804 include “Search for apples available for pickup.” A search engine 912 is selected to implement a corresponding search workflow. The item information 810 includes an item type (e.g., “apples”), and the fulfillment type 812 is “pickup.” In accordance with the search workflow, the search engine 912 searches (operation 1012) a database 116 (FIG. 1) to identify, in the database 116, the one or more information items 802 belonging to the item type of “apples” and available for “pickup.”

The information processing module 222 may send the one or more information items 802 to a user application 218. The user application 218 may prepare (operation 1014) a user interface including the one or more information items 802 and display (operation 1016) the user interface to a target user 122T. In some embodiments (FIG. 10), the target user 122T includes the first user 122A providing the query messages 804, and the first user 122A reviews the one or more information items 802 via the user application 218 collecting the query message(s) 804 from the first user 122A. For example, for “Search for apples available for pickup,” the one or more information items 802 are displayed on a user interface as a search result to the first user 122A. In some embodiments, the query messages 804 include “I want shipping items only,” which is obtained while a set of candidate information items 818 is displayed on a user interface to the first user 122A who provides the one or more query messages 804. The data operation type 814 includes a refinement option 814R for which the information source 816 includes the user interface that is displayed and the target user 122T includes the first user 122A. The set of candidate information items 818 is filtered based on the fulfillment type 812 (e.g., “shipping”) to generate the one or more information items 802 for display to the first user 122A.

In some embodiments, the target user 122T includes a second user 122B (FIG. 9) distinct form the first user 122A. The second user 122B reviews the one or more information items 802 in a different user interface of a different user application of a different electronic device. For example, the one or more query messages 804 include “add this item for shipping” and are obtained while the one or more information items 802 are already displayed on a user interface to the first user 122A who provides the one or more query messages 804. The set of candidate information items 818 includes the one or more information items 802. The data operation type 814 (e.g., “add”) includes an engagement option 814E for which the information source 816 includes the user interface that is displayed and the target user 122T includes a second user 122B. An engagement request is generated based on the one or more information items 802, and the one or more information items 802 are displayed to the target user 122T in response to the engagement request. The target user 122T reviews the engagement requests and prepares the items associated with the one or more information items 802 for “shipping.”

In some embodiments, a combination of “search” with a fulfillment type 812 may be applied with different utterances in different use cases, allowing a user 122 to search for an item 808 and review corresponding information item(s) 802 based on the fulfilment type 812. For example, the fulfilment type 812 may be determined based on the query messages 804 including “pickup”, “delivery”, “in-store,” and “shipping.” The user 122 may speak close to a screen of the electronic device 112A (FIG. 9) with utterances, e.g., “Search apples available for pickup” or “Search milk available in store.” The one or more information items 802 are displayed on a user interface of the user application 218 in response to the utterances. In some embodiments, the one or more information items 802 correspond to one or more items 808 that match the item information 810 determined from the utterances, and are available for a pickup from the user's preferred store. Such a voice-activated fulfillment process provides hands-free online information search experience to the users 122.

In some embodiments, the data operation type 814 is an engagement option 814E (e.g., “book a slot”) configured to schedule a time slot for a pickup or a delivery. Example query messages include utterances of “Book a slot for me to pick up my grocery order.” In some embodiments, a user 122 follows a sequence of user interfaces displayed on an electronic device 112A to schedule a time, which cannot be done while driving. A voice-activated engagement option 814E provides hands-free experience to users 112 to book a slot based on a preferred date and time. The user 122 may provide a query message 804 via a microphone in an instinctive way with natural language. In some embodiments, the user 122 is prompted with one or more questions in audio messages, and the user's answers are collected as query messages 804 that clarify details of the user request 806. Further, in an example, a question includes a recommendation of an earliest available time slot at a specific store. Stated another way, in some embodiments, a user request 806 is generated with a plurality of query messages 804, and two of the plurality of query messages 804 may be interrupted by a machine-generated question. The machine generated question may be regarded as one of the query message 804 or a part of context used by a context mining module 904 (FIG. 9).

In some embodiments, the data operation type 814 is an engagement option 814E (e.g., “add to cart,” “reorder,” “order again”) configured to provide users 112 with hands-free add to cart experience. Example query messages include utterances of “Add apples to my cart for pickup.” The information processing system 900 (FIG. 9) may automatically predict one or more items a user 122 intends to add based on a search of a purchase history and add the predicted item(s) into the user's virtual shopping cart, thereby avoiding the user's further review and saving the user's time.

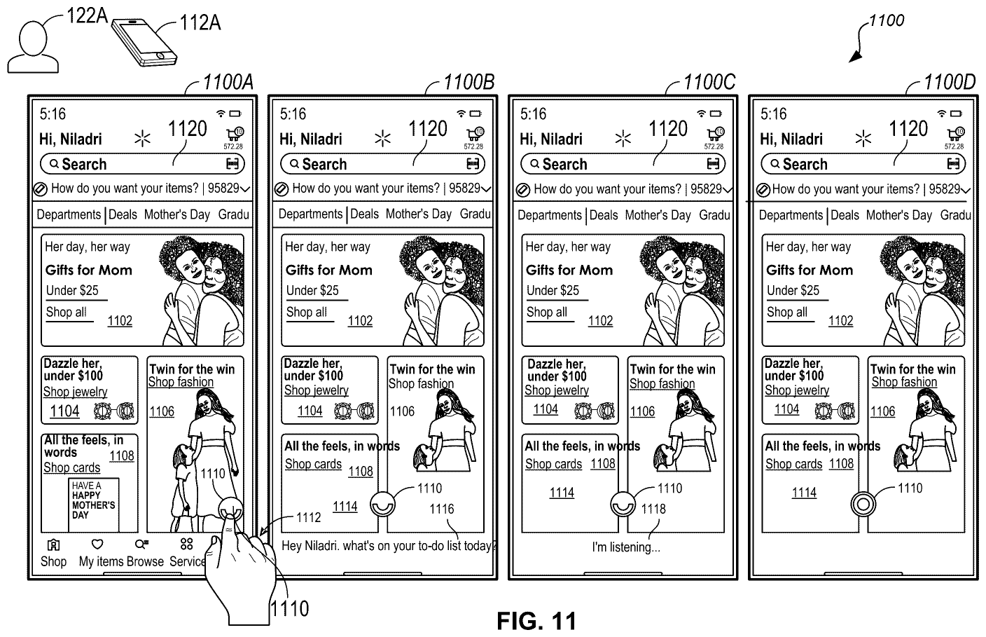

FIG. 11 is a diagram illustrating a set of graphic user interfaces 1100 (e.g., 1100A-1100D) displayed for receiving and processing natural language query messages 804, in accordance with some embodiments. A user application 218 is executed, and displays user interfaces 1100A-1100D, on an electronic device 112A associated with a first user 122A. Each of the user interfaces 1100A-1100D is selected from: a content page, an order detail page, an account setting page, a product landing page, and an item detail page. Referring to FIG. 11, each user interface 1100 may be a content page including four regions 1102, 1104, 1106, and 1108 where four advertisements are displayed. The user interface 1100A includes a voice assistant affordance item 1110 overlaid on top of a region 1106 and overlaps content of an advertisement displayed in the region 1106. The voice assistant affordance item 1110A may be displayed on the user interface 1100, independently of content concurrently displayed on the user interface 1100A (e.g., when the user interface 1100A is any of a content page, an order detail page, an account setting page, a product landing page, and an item detail page). In some embodiments, the voice assistance affordance item 1110 may be dragged to any position of the user interface 1100A.

In some embodiments, while the voice assistance affordance item 1110 is displayed on the user interface 1100A, a user action 1112 (e.g., a click) is detected on the voice assistance affordance item 1110, In response to detection of the user action 1112, a voice assistance mode is enabled, and a microphone of the electronic device 112A is activated to collect an audio signal. In some embodiments, while the microphone is activated with a voice assistance mode, a focus region 1114 is enabled on the user interfaces 1100B-1100D, e.g., covering a subset of the regions 1102-1108 displaying the advertisements. The voice assistance affordance item 1110 is displayed on the focus region 1114. The user interface 1110B may further display a prompt 1116 (e.g., “Hey, Niladri, what's on your to-do-list today?”) on the focus region 1114, and the prompt 1116 may be concurrently broadcast by a speaker of the electronic device 112A. In some situations, the user interface 1110C may further display a message 1118 indicating a state of the user application on the focus region 1114. For example, the message 1118 is “I am listening . . . ,” indicating the microphone of the electronic device 112A is collecting the audio signal. In some embodiments, the user interface 1110D does not display any message with the voice assistance affordance item 1110 on the focus region 1114. A visual pattern of the voice assistance affordance item 1110 displayed on the user interface 1110D is distinct from a respective visual pattern of the affordance item 1110 on any of the other user interfaces 1110A-1110C, indicating that the audio signal is being converted to digital data. A subset of the audio signal is converted to the one or more query messages 804.

In some embodiments, the user interface 1100 includes a text box 1120 where the one or more query messages 804 may be typed (e.g., at once or successively). More details on using the query messages 804 entered via the microphone or the text box 1120 to enable fulfillment-based information presentation are discussed above with reference to FIGS. 8-10. For example, a user 122A may use utterances (e.g., “Search for apples available for pickup,” “Search for milk available in store”) to enable hands-free user experience on a cloud-based information platform. The utterances are analyzed to extract item information 810 of items 808 that interest the user 122A, a fulfillment type 812, and a data operation type 814. Result pages having one or more information items 802 are presented for review by a target user 122T, who may be the user 122A or a different user 122B.

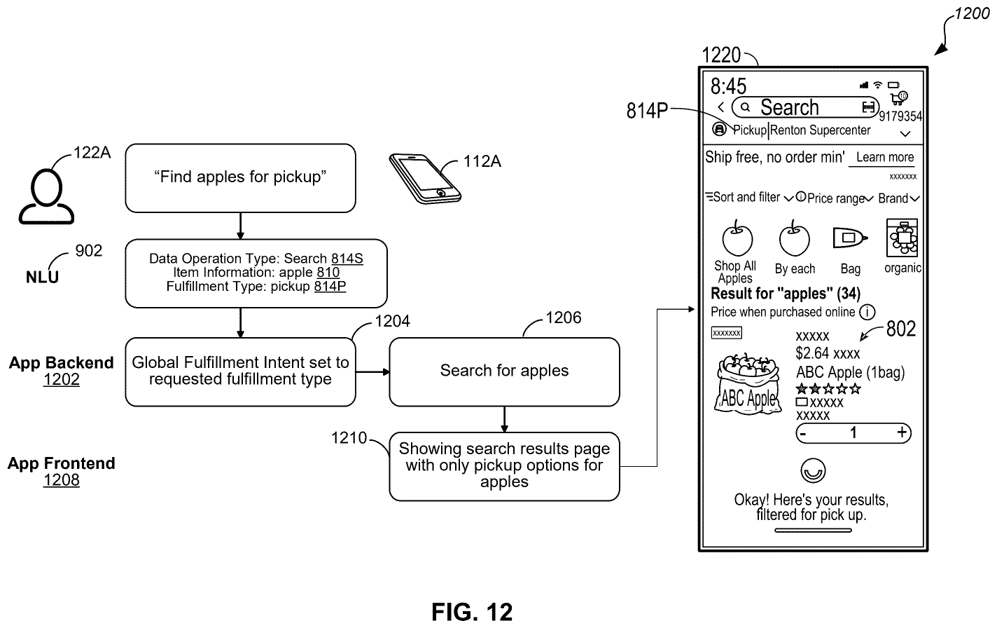

FIG. 12 is a flow diagram of a method 1200 of rendering a user interface 1220 including an information item 802 that is identified in response to an example query message 804, in accordance with some embodiments. The query message 804 is collected by an electronic device 112A associated with a first user 122A. The query message 804 is “Find apples for pickup.” The natural language unit 902 of the information processing module 222 (FIG. 9) analyzes the query message 804, and determines item information 810 associated with one or more items 808, a fulfillment type 812 for managing the one or more items 808, and a data operation type 814 for processing the item information 810. The item information 810 includes “apple,” which defines an item type for the one or more items 808. The data operation type 814 includes a search option 814S, and the fulfillment type 812 includes a pickup option 812P.

In an application backend 1202, the fulfillment type 812 is adopted (operation 1204), and a search for apples is performed (operation 1206). In an application frontend 1208, a search result page is presented on the user interface 1220 and includes (operation 1210) one or more information items 802 corresponding to apple products that are available for pickup. The user interface 1220 displays an information item 802 associated with apples. The fulfillment type 814P may be indicated on the user interface 1220.

In some embodiments, while the information item 802 is displayed on the user interface 1220, another query message 804 is received. For example, the query message 804 is “Add this item to cart,” which is analyzed to extract item information 810 reciting “this item” without specifying an item type or an item name. An item associated with the information item 802 is added to cart. Another information item associated with the information item 802 is identified and presented to a target user 122T (e.g., a store clerk), allowing the target user 122T to prepare an associated pickup order.

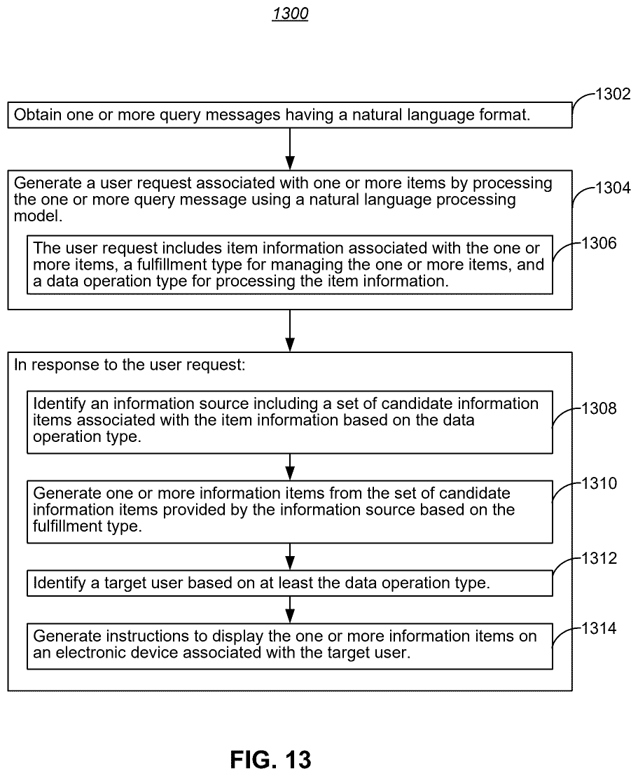

FIG. 13 is a flowchart illustrating a method 1300 for managing information, in accordance with some embodiments. The method 1300 is implemented by a system (e.g., including a computing device 102 and/or a cloud-based engine 121 in FIG. 1). Method 1300 may be governed by instructions that are stored in a non-transitory computer readable storage medium and that are executed by one or more processors of a system (e.g., a computing device 102). Each of the operations shown in FIG. 13 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1300 may be combined and/or the order of some operations may be changed.

A system (a computing device 102 and/or the cloud-based engine 121 in FIG. 1) obtains (operation 1302) one or more query messages 804 having a natural language format. The system generates (operation 1304) a user request 806 associated with one or more items 808 by processing the one or more query messages 804 using a natural language processing model 224. The user request 806 includes (operation 1306) item information 810 associated with the one or more items 808, a fulfillment type 812 for managing the one or more items 808, and a data operation type 814 for processing the item information 810. In response to the user request 806, the system identifies (operation 1308) an information source 816 including a set of candidate information items 818 associated with the item information 810 based on the data operation type 814, generates (operation 1310) one or more information items 802 from the set of candidate information items 818 provided by the information source 816 based on the fulfillment type 812, identifies (operation 1312) a target user 122T based on at least the data operation type 814, and generates (operation 1314) instructions to display the one or more information items 802 on an electronic device 112T associated with the target user 122T (FIG. 8).

In some embodiments, the information source 816 includes a plurality of data sets stored in one or more databases (e.g., database 116). The fulfillment type 812 is selected from a delivery option 812D associated with a first data set, a shipping option 812S associated with a second data set, and a pickup option 812P associated with a third data set. The one or more information items 802 are extracted based on at least one of the first data set, the second data set, and the third data set stored in the one or more databases based on the fulfillment type 812.

In some embodiments, the information source 816 includes a database 116 (FIG. 1), each candidate information item is stored with a fulfillment indicator in the database 116. The one or more information items 802 are extracted from the database 116 based on the fulfillment indicator of each of the one or more information items 802.

In some embodiments, the data operation type 814 is selected from a search option 814S, a refinement option 814R, and an engagement option 814E (FIG. 9). Further, in some embodiments, a first user 122A belonging to a first user group and providing the one or more query messages 804 is identified as the target user 122T in accordance with a determination that the data operation type 814 is the search option or the refinement option. In some embodiments, at least a second user 122B (FIG. 9) belonging to a second user group associated with the system is identified as the target user 122T in accordance with a determination that the data operation type 814 is the engagement option 814E.

In some embodiments, the data operation type 814 includes a search option for which a database 116 is identified as the information source 816, and the target user 122T includes a first user 122A who provides the one or more query messages 804. The one or more information items 802 are identified in a search of the database 116 based on the item information 810 and the fulfillment type 812, and displayed on a user interface as a search result to the first user 122A.

In some embodiments, the one or more query messages 804 are obtained while the set of candidate information items 818 is displayed on a user interface to a first user 122A who provides the one or more query messages 804. The data operation type 814 includes a refinement option 814R for which the information source 816 includes the user interface and the target user 122T includes the first user 122A. The set of information items is filtered based on the fulfillment type 812 to generate the one or more information items 802 for display on the user interface.

In some embodiments, the one or more query messages 804 are obtained while the one or more information items 802 are already displayed on a user interface to a first user 122A who provides the one or more query messages 804. The set of candidate information items 818 include the one or more information items 802. The data operation type 814 includes an engagement option for which the information source 816 includes the user interface and the target user 122T includes a second user. An engagement request is generated based on the one or more information items 802, and the one or more information items 802 are displayed to the target user 122T in response to the engagement request.

In some embodiments, the system executes a user application 218 including enabling display of a user interface (e.g., 1100A-1100D in FIG. 11), and enables display of a voice assistant affordance item 1110 on the user interface, independently of content concurrently displayed on the user interface. In response to detection of a user action 1112 (FIG. 11) on the voice assistance affordance item 1110, the system obtains an audio signal collected via a microphone. A subset of the audio signal is converted to the one or more query messages 804.

In some embodiments, the system executes a user application 218 including enabling display of a user interface (e.g., 1100A-1100D in FIG. 11) associated with a user application 218. The one or more query messages 804 are entered by a first user 122A on the user interface.

In some embodiments, the one or more query messages 804 includes a sequence of two or more query messages 804 in the natural language format. The system generates a context including a plurality of context terms by processing each of the sequence of two or more query messages 804 using the natural language processing model 224 separately. The user request 806 is generated based on the context.

In some embodiments, the item information 810 includes an item type, and each of the one or more information items 802 represents a respective item of the item type and includes one or more of: a brand name, a quantity, a package size, a price, and an image of the respective item.

In some embodiments, the system enables display of a user interface including a first information item (e.g., 802 in FIG. 12). While the first information item is displayed, the system determines that the item information 810 recites an item without specifying an item type or an item name. At least one of the one or more information items 802 is generated based on the first information item.

Turning now to example embodiments in the following clauses:

Clause 1. A system, comprising: a non-transitory memory having instructions stored thereon; and at least one processor operatively coupled to the non-transitory memory, and configured to read the instructions to: obtain one or more query messages having a natural language format; generate a user request associated with one or more items by processing the one or more query messages using a natural language processing model, the user request including item information associated with the one or more items, a fulfillment type for managing the one or more items, and a data operation type for processing the item information; and in response to the user request: identify an information source including a set of candidate information items associated with the item information based on the data operation type; generate one or more information items from the set of candidate information items provided by the information source based on the fulfillment type; identify a target user based on at least the data operation type; and generate instructions to display the one or more information items on an electronic device associated with the target user.

Clause 2. The system of clause 1, wherein: the information source includes a plurality of data sets stored in one or more databases; the fulfillment type is selected from a delivery option associated with a first data set, a shipping option associated with a second data set, and a pickup option associated with a third data set; and the one or more information items are extracted based on at least one of the first data set, the second data set, and the third data set stored in the one or more databases based on the fulfillment type.

Clause 3. The system of clause 1, wherein: the information source includes a database, each candidate information item is stored with a fulfillment indicator in the database; and the one or more information items are extracted from the database based on the fulfillment indicator of each of the one or more information items.

Clause 4. The system of any of clauses 1-3, wherein: the data operation type is selected from a search option, a refinement option, and an engagement option; and a first user belonging to a first user group and providing the one or more query messages is identified as the target user in accordance with a determination that the data operation type is the search option or the refinement option.

Clause 5. The system of any of clauses 1-3, wherein: the data operation type is selected from a search option, a refinement option, and an engagement option; a first user belongs to a first user group and provides the one or more query messages; and at least a second user belonging to a second user group associated with the system is identified as the target user in accordance with a determination that the data operation type is the engagement option.

Clause 6. The system of any of clauses 1-3, wherein: the data operation type includes a search option for which a database is identified as the information source, and the target user includes a first user who provides the one or more query messages; and the one or more information items are identified in a search of the database based on the item information and the fulfillment type, and displayed on a user interface as a search result to the first user.

Clause 7. The system of any of clauses 1-3, wherein: the one or more query messages are obtained while the set of candidate information items is displayed on a user interface to a first user who provides the one or more query messages; the data operation type includes a refinement option for which the information source includes the user interface and the target user includes the first user; and the set of information items is filtered based on the fulfillment type to generate the one or more information items for display on the user interface.

Clause 8. The system of any of clauses 1-3, wherein: the one or more query messages are obtained while the one or more information items are already displayed on a user interface to a first user who provides the one or more query messages, the set of candidate information items including the one or more information items; the data operation type includes an engagement option for which the information source includes the user interface and the target user includes a second user; and an engagement request is generated based on the one or more information items, and the one or more information items are displayed to the target user in response to the engagement request.

Clause 9. The system of any of clauses 1-8, further comprising instructions to: execute a user application including enabling display of a user interface; enable display of a voice assistant affordance item on the user interface, independently of content concurrently displayed on the user interface; and in response to detection of a user action on the voice assistance affordance item, obtaining an audio signal collected via a microphone, wherein a subset of the audio signal is converted to the one or more query messages.

Clause 10. The system of any of clauses 1-8, further comprising instructions to: execute a user application including enabling display of a user interface associated with a user application, wherein the one or more query messages are entered by a first user on the user interface.

Clause 11. The system of any of clauses 1-10, wherein the one or more query messages includes a sequence of two or more query messages in the natural language format, and the instructions to generate the user request further comprise instructions to: generate a context including a plurality of context terms by processing each of the sequence of two or more query messages using the natural language processing model separately, wherein the user request is generated based on the context.

Clause 12. The system of any of clauses 1-11, wherein the item information includes an item type, and each of the one or more information items represents a respective item of the item type and includes one or more of: a brand name, a quantity, a package size, a price, and an image of the respective item.

Clause 13. The system of any of clauses 1-12, further comprising instructions to: enable display of a user interface including a first information item; and while the first information item is displayed, determine that the item information recites an item without specifying an item type or an item name, wherein at least one of the one or more information items is generated based on the first information item.

Clause 14. A non-transitory computer-readable storage medium, having instructions of a system of any of claims 1-13 stored thereon, which when executed by one or more processors cause the processors to implement operations based on the instructions.

Clause 15. A method, comprising: at a system including a non-transitory memory having instructions stored thereon and at least one processor operatively coupled to the non-transitory memory and configured to read the instructions, implementing operations based on the instructions of a system of any of claims 1-13.

It should be understood that the particular order in which the operations in FIG. 12 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-13 are also applicable in an analogous manner to method 1200 described above with respect to FIG. 12. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain one or more query messages having a natural language format;
generate a user request associated with one or more items by processing the one or more query messages using a natural language processing model, the user request including item information associated with the one or more items, a fulfillment type for managing the one or more items, and a data operation type for processing the item information; and
in response to the user request:
identify an information source including a set of candidate information items associated with the item information based on the data operation type;
generate one or more information items from the set of candidate information items provided by the information source based on the fulfillment type;
identify a target user based on at least the data operation type; and
generate instructions to display the one or more information items on an electronic device associated with the target user.

2. The system of clause 1, wherein:
the information source includes a plurality of data sets stored in one or more databases;
the fulfillment type is selected from a delivery option associated with a first data set, a shipping option associated with a second data set, and a pickup option associated with a third data set; and
the one or more information items are extracted based on at least one of the first data set, the second data set, and the third data set stored in the one or more databases based on the fulfillment type.

3. The system of clause 1, wherein:
the information source includes a database, each candidate information item is stored with a fulfillment indicator in the database; and
the one or more information items are extracted from the database based on the fulfillment indicator of each of the one or more information items.

4. The system of claim 1, wherein:
the data operation type is selected from a search option, a refinement option, and an engagement option; and
a first user belonging to a first user group and providing the one or more query messages is identified as the target user in accordance with a determination that the data operation type is the search option or the refinement option.

5. The system of claim 1, wherein:
the data operation type is selected from a search option, a refinement option, and an engagement option;
a first user belongs to a first user group and provides the one or more query messages; and
at least a second user belonging to a second user group associated with the system is identified as the target user in accordance with a determination that the data operation type is the engagement option.

6. The system of claim 1, wherein:
the data operation type includes a search option for which a database is identified as the information source, and the target user includes a first user who provides the one or more query messages; and
the one or more information items are identified in a search of the database based on the item information and the fulfillment type, and displayed on a user interface as a search result to the first user.

7. The system of claim 1, wherein:
the one or more query messages are obtained while the set of candidate information items is displayed on a user interface to a first user who provides the one or more query messages;
the data operation type includes a refinement option for which the information source includes the user interface and the target user includes the first user; and
the set of information items is filtered based on the fulfillment type to generate the one or more information items for display on the user interface.

8. The system of claim 1, wherein:
the one or more query messages are obtained while the one or more information items are already displayed on a user interface to a first user who provides the one or more query messages, the set of candidate information items including the one or more information items;
the data operation type includes an engagement option for which the information source includes the user interface and the target user includes a second user; and
an engagement request is generated based on the one or more information items, and the one or more information items are displayed to the target user in response to the engagement request.

9. The system of claim 1, further comprising instructions to:
execute a user application including enabling display of a user interface;
enable display of a voice assistant affordance item on the user interface, independently of content concurrently displayed on the user interface; and
in response to detection of a user action on the voice assistance affordance item, obtaining an audio signal collected via a microphone, wherein a subset of the audio signal is converted to the one or more query messages.

10. The system of claim 1, further comprising instructions to:
execute a user application including enabling display of a user interface associated with a user application, wherein the one or more query messages are entered by a first user on the user interface.

11. A non-transitory computer-readable storage medium, having instructions stored thereon, which when executed by one or more processors cause the processors to:
obtain one or more query messages having a natural language format;
generate a user request associated with one or more items by processing the one or more query messages using a natural language processing model, the user request including item information associated with the one or more items, a fulfillment type for managing the one or more items, and a data operation type for processing the item information; and
in response to the user request:
identify an information source including a set of candidate information items associated with the item information based on the data operation type;
generate one or more information items from the set of candidate information items provided by the information source based on the fulfillment type;
identify a target user based on at least the data operation type; and
generate instructions to display the one or more information items on an electronic device associated with the target user.

12. The non-transitory computer-readable storage medium of claim 11, wherein the one or more query messages includes a sequence of two or more query messages in the natural language format, and the instructions to generate the user request further comprise instructions to: generate a context including a plurality of context terms by processing each of the sequence of two or more query messages using the natural language processing model separately, wherein the user request is generated based on the context.

13. The non-transitory computer-readable storage medium of claim 11, wherein the item information includes an item type, and each of the one or more information items represents a respective item of the item type and includes one or more of: a brand name, a quantity, a package size, a price, and an image of the respective item.

14. The non-transitory computer-readable storage medium of claim 11, further comprising instructions to:
enable display of a user interface including a first information item; and
while the first information item is displayed, determine that the item information recites an item without specifying an item type or an item name, wherein at least one of the one or more information items is generated based on the first information item.

15. A computer-implemented method, comprising:
obtaining one or more query messages having a natural language format;
generating a user request associated with one or more items by processing the one or more query messages using a natural language processing model, the user request including item information associated with the one or more items, a fulfillment type for managing the one or more items, and a data operation type for processing the item information; and
in response to the user request:
identifying an information source including a set of candidate information items associated with the item information based on the data operation type;
generating one or more information items from the set of candidate information items provided by the information source based on the fulfillment type;
identifying a target user based on at least the data operation type; and
generating instructions to display the one or more information items on an electronic device associated with the target user.

16. The computer-implemented method of clause 15, wherein:
the information source includes a plurality of data sets stored in one or more databases;
the fulfillment type is selected from a delivery option associated with a first data set, a shipping option associated with a second data set, and a pickup option associated with a third data set; and
the one or more information items are extracted based on at least one of the first data set, the second data set, and the third data set stored in the one or more databases based on the fulfillment type.

17. The computer-implemented method of clause 15, wherein:
the information source includes a database, each candidate information item is stored with a fulfillment indicator in the database; and
the one or more information items are extracted from the database based on the fulfillment indicator of each of the one or more information items.

18. The computer-implemented method of claim 15, wherein:
the data operation type is selected from a search option, a refinement option, and an engagement option; and
a first user belonging to a first user group and providing the one or more query messages is identified as the target user in accordance with a determination that the data operation type is the search option or the refinement option.

19. The computer-implemented method of claim 15, wherein:
the data operation type is selected from a search option, a refinement option, and an engagement option;
a first user belongs to a first user group and provides the one or more query messages; and
at least a second user belonging to a second user group associated with the system is identified as the target user in accordance with a determination that the data operation type is the engagement option.

20. The computer-implemented method of claim 15, wherein:
the data operation type includes a search option for which a database is identified as the information source, and the target user includes a first user who provides the one or more query messages; and
the one or more information items are identified in a search of the database based on the item information and the fulfillment type, and displayed on a user interface as a search result to the first user.
